(19) United States
(12) Patent Application Publication
(10) Pub. No.: US 2023/0416463 A1
(43) Pub. Date: Dec. 28, 2023

(54) FUNCTIONALIZED POLYGLYCINE-POLY(ALKYLENIMINE) COPOLYMERS, THEIR PREPARATION AND USE FOR PREPARING ACTIVE INGREDIENT FORMULATIONS AND SPECIAL-EFFECT SUBSTANCE FORMULATIONS

(71) Applicant: FRIEDRICH-SCHILLER-UNIVERSITÄT JENA, Jena (DE)

(72) Inventors: Christine Weber, Jena (DE); Natalie Göppert, Jena (DE); Ulrich S. Schubert, Jena (DE)

(73) Assignee: FRIEDRICH-SCHILLER-UNIVERSITÄT JENA, Jena (DE)

(21) Appl. No.: 18/253,693

(22) PCT Filed: Nov. 19, 2021
(86) PCT No.: PCT/EP21/00146

§ 371 Date: May 19, 2023

(30) Foreign Application Priority Data
Nov. 21, 2020 (DE) 102020007116.3

(51) Int. Cl. C08G 73/02; C08G 69/10; C08G 69/04

(52) U.S. Cl. CPC C08G 73/0233; C08G 69/10; C08G 2310/00; C08G 2230/00; C08G 69/04

(57) ABSTRACT

The invention relates to copolymers that contain structural units of the formula (I), of the formula (II) and optionally of the formula (III) —NR¹—CHR³—CHR⁴— (I), —NH—CO—CHR⁷— (II), —NH—CHR⁹—CHR¹⁰— (III), or structural units of the formula (IV), of the formula (V) and optionally of the formula (VI) NR¹—CHR³—CHR⁴—CHR⁵— (IV), —NH—CO—CHR⁷—CHR⁸— (V), —NH—CHR⁹—CHR¹⁰—CHR¹¹— (VI), wherein R¹ is a residue of the formula —CO—R², of the formula —CO—NH—R² or of the formula —CH₂—CH(OH)—R¹², R³, R⁴, R⁵, R⁷, R⁸, R⁹, R¹⁰ and R¹¹ independently of each other represent hydrogen, methyl, ethyl, propyl or butyl, and R² and R¹² represent hydrogen or selected organic residues. These copolymers are characterized by good degradability and can be used, for example, for preparing active ingredient formulations.

The invention relates to new copolymers which can be described as functionalized polyglycine-polyalkyleneimine copolymers characterized by very good degradability. In particular, the invention relates to the preparation and processing of these copolymers by oxidation of polyalkyleneimines followed by functionalization of NH groups in the partially oxidized polymer backbone. These copolymers can be used in particular for the preparation of active ingredient and effect ingredient formulations.

Biocompatible polymers represent highly attractive materials for biomedical applications such as drug delivery. Poly(ethylene glycol) (PEG) is currently the most widely used polymer for such purposes. Due to its high hydrophilicity and so-called “masking behavior,” it elicits little immune response in the body, thus increasing the blood circulation time of the drug. However, PEG has several disadvantages, namely the formation of toxic by-products, sequestration in organs, and stimulation of anti-PEG antibodies.

Poly(2-n-alkyl-2-oxazolines) (PAOx) with short side chains show similar hydrophilicity, biocompatibility and “masking behavior” and therefore seem to be promising candidates for a replacement of PEG, which was further confirmed in a detailed comparison of their dissolution behavior (cf. Grube, M.; Leiske, M. N.; Schubert, U. S.; Nischang, I. POx as an alternative to PEG? A hydrodynamic and light scattering study. Macromolecules 2018, 51, 1905-1916). Unlike PEG, PAOx also exhibit higher structural versatility due to their side-chain modifiability.

PAOx with longer side chains are hydrophobic and can be used to prepare amphiphilic copolymers, low surface energy materials, or low adhesion coatings. Thermal and crystalline properties can also be tailored by variations in the PAOx side chains (cf. Hoogenboom, R.; Fijten, M. W. M.; Thijs, H. M. L.; van Lankvelt, B. M.; Schubert, U. S. Microwave-assisted synthesis and properties of a series of poly(2-alkyl-2-oxazoline)s. Des. Monomers Polym. 2005, 8, 659-671; Rettler, E. F. J.; Kranenburg, J. M.; Lambermont-Thijs, H. M. L.; Hoogenboom, R.; Schubert, U. S. Thermal, mechanical, and surface properties of poly(2-N-alkyl-2-oxazoline)s Macromol. Chem. Phys. 2010, 211, 2443-2448; Kempe, K.; Lobert, M.; Hoogenboom, R.; Schubert, U. S. Synthesis and characterization of a series of diverse poly(2-oxazoline)s. J. Polym. Sci., Part A: Polym. Chem. 2009, 47, 3829-3838; Beck, M.; Birnbrich, P.; Eicken, U.; Fischer, H.; Fristad, W. E.; Hase, B.; Krause, H.-J. Polyoxazolines on a lipid chemical basis. Angew. Makromol. Chem. 1994, 223, 217-233; Rodríguez-Parada, J. M.; Kaku, M.; Sogah, D. Y. Monolayers and Langmuir-Blodgett films of poly(AT-acylethylenimines) with hydrocarbon and fluorocarbon side chains. Macromolecules 1994, 27, 1571-1577; Oleszko-Torbus, N.; Utrata-Wesotek, A.; Bochenek, M.; Lipowska-Kur, D.; Dworak, A.; Watach, W. Thermal and crystalline properties of poly(2-oxazoline)s. Polym. Chem. 2020, 11, 15-33; Demirel, A. L.; Tatar, G. P.; Verbraeken, B.; Schlaad, H.; Schubert, U. S.; Hoogenboom, R. Revisiting the crystallization of poly(2-alkyl-2-oxazoline)s. J. Polym. Sci., Part B: Polym. Phys. 2016, 54, 721-729). Schubert and colleagues previously reported a decrease in glass transition temperature (T_{g}) with increasing side chain length for a range of poly(2-n-alkyl-2-oxazolines) to poly(2-pentyl-2-oxazolines). For PAOx with longer side chains, crystalline properties with a melting temperature Tₘ independent of side chain length were observed.

However, PAOx as well as PEG are considered non-biodegradable. For a variety of applications in biomedicine and other fields, biodegradability would be an important property, for example, to prevent polymers with molecular masses beyond 20,000 g mol⁻¹ from accumulating in the body and to remove the polymer completely from the organism. One strategy to solve the problem could be to integrate hydrolytically sensitive groups into the polymer backbone, e.g. ester or amide units. These can be hydrolyzed under, for example, acidic or enzymatic conditions, which could lead to degradation of the entire polymer. Several routes have already been investigated to incorporate ester groups into the PAOx backbone. Recently, the synthesis of a series of poly(esteramides) with lateral amide linkages prepared by organocatalytic ring-opening polymerization of N-acetylated-1,4-oxazepan-7-one monomers has been reported (ref. Wang, X.; Hadjichristidis, N. Organocatalytic ring-opening polymerization of N-acylated-1,4-oxazepan-7-ones toward well-defined poly(ester amide)s: biodegradable alternatives to poly(2-oxazoline)s. ACS Macro Lett. 2020, 9, 464-470). The resulting polymers can be considered as alternating poly(ester-co-oxazolines) and therefore as biodegradable PAOx alternatives. In the series of differentially degradable poly-(2-alkyl-2-oxazoline) and poly(2-aryl-2-oxazoline) analogs, all polymers exhibited amorphous behavior and showed lower T_{g} compared to their non-degradable PAOx counterparts.

Recently, polymers consisting of the same repeating units synthesized by spontaneous zwitterionic copolymerization of 2-oxazoline and acrylic acid were reported to give N-acylated poly(amino ester) macromonomers. Downstream redox-initiated reversible addition-fragmentation chain transfer (RRAFT) polymerization of these macromonomers resulted in biodegradable comb polymers (cf. Kempe, K.; de Jongh, P. A.; Anastasaki, A.; Wilson, P.; Haddleton, D. M. Novel comb polymers from alternating N-acylated poly(aminoester)s obtained by spontaneous zwitterionic copolymerization. Chem. Commun. 2015, 51, 16213-16216; de Jongh, P. A. J. M.; Mortiboy, A.; Sulley, G. S.; Bennett, M. R.; Anastasaki, A.; Wilson, P.; Haddleton, D. M.; Kempe, K. Dual stimuli-responsive comb polymers from modular N-acylated poly(aminoester)-based macromonomers. ACS Macro Lett. 2016, 5, 321-325).

Other approaches used amidation of diethanolamine, resulting in different hydroxyethylsuccinamide monomers, followed by polycondensation of these monomers with succinic acid, aiming at similar polymer structures (cf. Swanson, J. P.; Monteleone, L. R.; Haso, F.; Costanzo, P. J.; Liu, T.; Joy, A. A library of thermoresponsive, coacervate-forming biodegradable polyesters. Macromolecules 2015, 48, 3834-3842; Gokhale, S.; Xu, Y.; Joy, A. A library of multifunctional polyesters with “peptide-like” pendant functional groups. Biomacromolecules 2013, 14, 2489-2493).

However, to the best of our knowledge, no attempts have been made to introduce amide bonds into a polyoxazoline backbone or into a backbone of other functionalized polyalkylene imines for the purpose of improving degradability.

It is therefore an objective of the present invention to provide new functionalized copolymers with improved degradability.

A further objective of the present invention is to provide a simple method for the preparation of these functionalized copolymers.

This objective is solved by providing copolymers containing
10 to 95 mol % of structural units of the formula (I),
5 to 90 mol % of structural units of the formula (II) and
0 to 20 mol % of structural units of the formula (III)

—NR¹—CHR³—CHR⁴— (I),

—NH—CO—CHR⁷— (II),

—NH—CHR⁹—CHR¹⁰— (III),

or of

copolymers containing
10 to 95 mol % of structural units of the formula (IV),
5 to 90 mol % of structural units of the formula (V) and
0 to 20 mol % of structural units of the formula (VI)

—NR¹—CHR³—CHR⁴—CHR⁵— (IV),

—NH—CO—CHR⁷—CHR⁸— (V),

—NH—CHR⁹—CHR¹⁰—CHR¹¹— (VI),

wherein
R¹ is a radical of the formula —CO—R², of the formula —CO—NH—R² or of the formula CH₂—CH(OH)—R¹²,
R³, R⁴, R⁵, R⁷, R⁸, R⁹, R¹⁰ and R¹¹ independently of one another are hydrogen, methyl, ethyl, propyl or butyl,
R² is selected from the group consisting of hydrogen, alkyl, cycloalkyl, aryl, aralkyl, —CₘH₂ₘ—X or —(CₙH₂ₙ—O)ₒ—(CₚH₂ₚ—O)_{q}—R⁶,
R⁶ is hydrogen or C₁-C₆ alkyl,
R¹² is selected from the group consisting of hydrogen, alkyl, alkenyl, cycloalkyl, aryl or aralkyl,
X is selected from the group consisting of hydroxyl, alkoxy, carboxyl, carboxylic acid ester, sulfuric acid ester, sulfonic acid ester or carbamic acid ester,
m is an integer from 1 to 18,
n and p independently of one another are integers from 2 to 4, where n is not equal to p, and
o and q independently of one another are integers from 0 to 60, at least one of o or q not being equal to 0, the percentages being based on the total amount of the structural units of the formula (I), (II) and (III) or of the formula (IV), (V) and (VI).

These copolymers can be prepared starting from readily accessible poly(alkylene imines).

Therefore, the invention also relates, in a first variant, to a process for the preparation of these copolymers comprising the steps of
i) reacting a polyalkyleneimine containing recurring structural units of formula (Ia) or of formula (IVa), preferably in an amount of at least 90 mol %, with an oxidizing agent, thereby obtaining a copolymer containing the structural units of formula (Ia) and of formula (II) or containing the structural units of formula (IVa) and of formula (V)

—NH—CR³H—CR⁴H— (Ia),

—NH—CO—CR⁷H— (II),

—NH—CR³H—CR⁴H—CR⁵H— (IVa),

—NH—CO—CR⁷H—CR⁸H— (V),

wherein R³, R⁴, R⁵, R⁷ and R⁸ have the meaning defined above, and
ii) reacting the copolymer of step i) with an acyl derivative of the formula (VII) or with an isocyanate of the formula (VIII) or with an epoxide of the formula (IX) to give a copolymer containing the structural units defined above of the formulae (I), (II) and optionally (III) or of the formulae (IV), (V) and optionally (VI)

R²—CO—R¹³ (VII),

R²—NCO (VIII),

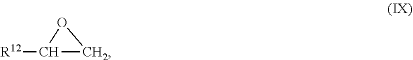

wherein R² and R¹² have the meaning defined above and
R¹³ represents a leaving group, in particular fluorine, chlorine, bromine, iodine or another leaving group of an activated carboxylic acid derivative.

Furthermore, the invention relates, in a second variant, to a process for the preparation of these copolymers, comprising the steps of
iii) partial hydrolysis of a polyoxazoline containing recurring structural units of formula (I) or a polyoxazine containing recurring structural units of formula (IV)

—NR¹—CHR³—CHR⁴— (I),

—NR¹—CHR³—CHR⁴—CHR⁵— (IV),
to a copolymer comprising the recurring structural units of the formula (I) and the formula (III) or the formula (IV) and the formula (VI)

—NH—CHR⁹—CHR¹⁰— (III),

—NH—CHR⁹—CHR¹⁰—CHR¹¹— (VI),
wherein R¹, R³, R⁴, R⁵, R⁹, R¹⁰ and R¹¹ have the meaning defined above, and
iv) reacting the copolymer from step iii) with an oxidizing agent, thereby obtaining a copolymer containing the structural units of formula (I), of formula (II) and optionally of the formula (III) or containing the structural units of formula (IV), of formula (V) and optionally of formula (VI)

—NH—CO—CHR⁷— (II),

—NH—CO—CHR⁷—CHR⁸— (V),

wherein R⁷ and R⁸ have the meaning defined above.

According to the invention, it was found that degradable functionalized polyglycine-polyalkyleneimine copolymers with amide linkages integrated into the polymer backbone can be prepared via a simple synthetic route. To this end, polyalkyleneimines can be partially oxidized and the resulting product can be functionalized via reaction with an epoxide, an isocyanate or an activated acyl derivative, such as an activated ester or an acyl halide. In an alternative synthetic route, polyoxazolines or polyoxazines can be partially hydrolyzed to give polyalkyleneimine units, which can be fully or partially oxidized in a subsequent step.

Polyalkyleneimines used in the first variant of the process according to the invention usually contain at least 90 mol % of recurring structural units of formula (Ia) or formula (IVa) and are commercially available or can be obtained by hydrolysis of poly(2-oxazolines) (POx) substituted in the 2-position, in particular of PEtOx, or of poly(2-oxazines) substituted in the 2-position.

POx containing at least 20 mol %, preferably at least 50 mol %, of recurring structural units derived from 2-oxazoline in the polymer are usually used as starting materials for hydrolysis. While commercially available polyalkyleneimines are branched, linear polyalkyleneimines are obtained by hydrolysis of POx.

In a second variant of the process according to the invention, hydrolysis of polyoxazolines or polyoxazines can also be partial and leads to copolymers containing recurring structural units of the formulae (I) and (III) or containing recurring structural units of the formulae (IV) and (VI). These copolymers can be oxidized, leading directly to the copolymers of the invention. In this process variant, reacylation is usually omitted.

A preferred simple synthetic route of post-polymerization is via the consecutive hydrolysis of poly(2-ethyl-2-oxazoline) (PEtOx), a partial oxidation and reacylation. The use of PEtOx or corresponding poly(2-alkyl-2-oxazolines) as well-defined starting materials is advantageous, since these polymers can be obtained by cationic ring-opening polymerization (CROP) of commercially available monomers. The subsequent hydrolysis of PEtOx or corresponding poly(2-alkyl-2-oxazolines) under acidic conditions, leading to linear poly(ethyleneimine) (PEI), is well studied, known to those skilled in the art, and can also be partially carried out. However, PEI is disadvantageous because of its cytotoxicity and, like PEtOx, its non-degradability. Englert et al. reported the controlled oxidation of linear PEI with hydrogen peroxide to enhance degradability by including amide groups in the PEI backbone (compare Enhancing the biocompatibility and biodegradability of linear poly(ethylene imine) through controlled oxidation; Macromolecules 2015, 48, 7420-7427). The resulting structure corresponds to the repeat unit of poly(glycine) and therefore the polymer can be considered as poly(ethyleneimine-co-glycine) (here referred to as oxPEI). Due to its additional hydrolytically sensitive amide groups, the polymer showed not only increased degradability but also improved biocompatibility compared to the otherwise cytotoxic PEI.

According to the invention, oxPEI was functionalized with a subsequent reacylation step or by reaction with isocyanates or with epoxides. Accordingly, the homologous polypropyleneimine (PPI) can also be used instead of PEI. Reacylation of oxPEI with acylation reagents, such as acyl halides, allowed the preparation of poly(2-n-alkyl-2-oxazoline-stat-glycine) (referred to here as dPAOx). Due to the presence of additional amide groups in the polymer backbone, it was suspected and also experimentally demonstrated that the resulting dPAOx exhibited enhanced degradability compared to their poly(2-n-alkyl-2-oxazoline) equivalents. Similar acylation reactions of PEI with activated carboxylic acid derivatives, such as acyl chlorides, anhydrides, or N-hydroxysuccinimide esters, have been reported previously in various ways (compare Mees, M. A.; Hoogenboom, R. Functional poly(2-oxazoline)s by direct amidation of methyl ester side chains. Macromolecules 2015, 48, 3531-3538; Sedlacek, O.; Monnery, B. D.; Hoogenboom, R. Synthesis of defined high molar mass poly(2-methyl-2-oxazoline). Polym. Chem. 2019, 10, 1286-1290; Englert, C.; Tauhardt, L.; Hartlieb, M.; Kempe, K.; Gottschaldt, M.; Schubert, U. S. Linear poly(ethylene imine)-based hydrogels for effective binding and release of DNA. Biomacromolecules 2014, 15, 1124-1131; Englert, C.; Trutzschler, A. K.; Raasch, M.; Bus, T.; Borchers, P.; Mosig, A. S.; Traeger, A.; Schubert, U. S. Crossing the blood-brain barrier: glutathione-conjugated poly(ethylene imine) for gene delivery. J. Controlled Release 2016, 241, 1-14; and Englert, C.; Prohl, M.; Czaplewska, J. A.; Fritzsche, C.; Preussger, E.; Schubert, U. S.; Traeger, A.; Gottschaldt, M. D-Fructose-decorated poly(ethylene imine) for human breast cancer cell targeting. Macromol. Biosci. 2017, 17, 1600502).

Re-functionalization of oxPEI or oxidized poly(propylene imine) (oxPPI) has not yet been described.

During the re-functionalization, the amount of acyl derivative of formula (VII) or of isocyanate of formula (VIII) or of epoxide of formula (IX) should be selected such that the proportion of structural units of formula (III) or of formula (VI) in the resulting copolymer is between 0 and 20 mol %.

In the context of the present description, “copolymers” means the above-mentioned organic compounds characterized by the repetition of certain units (monomer units or repeating units). The copolymers according to the invention consist of at least two types of different repeating units. Polymers are produced by the chemical reaction of monomers with the formation of covalent bonds (polymerization) and form the so-called polymer backbone by linking the polymerized units. This can have side chains on which functional groups can be located. Copolymers according to the invention consist of at least two different monomer units, which can be arranged randomly, as a gradient, alternately or as a block. If the copolymers possess partly hydrophobic properties, they can form nanoscale structures (e.g. nanoparticles, micelles, vesicles) in an aqueous environment.

In the context of the present description, “water-soluble compounds” or “water-soluble copolymers” are compounds or copolymers that dissolve to at least 1 g/L water at 25° C.

In the context of the present description, “active ingredients” are compounds or mixtures of compounds that exert a desired effect on a living organism. These may be, for example, pharmaceutical active ingredients or agrochemical active ingredients. Active ingredients may be low or high molecular weight organic compounds. Preferably, the active ingredients are low-molecular pharmaceutically active substances or higher-molecular pharmaceutically active substances, for example from potentially useful proteins, such as antibodies, interferons, cytokines.

The term “active pharmaceutical ingredient” is understood in the context of the present description to mean any inorganic or organic molecule, substance or compound that has a pharmacological effect. The term “active pharmaceutical ingredient” is used herein synonymously with the term “drug”.

In the context of this description, “effect substances” are compounds or mixtures of compounds that are added to a formulation to give it certain additional properties and/or to facilitate its processing. The terms “effect substances” and “auxiliaries and additives” are used synonymously in the context of this description.

In the context of the present description, the term “auxiliaries and additives” means substances that are added to a formulation in order to give it certain additional properties and/or to facilitate its processing. Examples of auxiliaries and additives are tracers, contrast agents, carriers, fillers, pigments, dyes, perfumes, slip agents, UV stabilizers, antioxidants or surfactants. In particular, “auxiliaries and additives” are to be understood as any pharmacologically compatible and therapeutically useful substance which is not a pharmaceutically active ingredient but which can be formulated together with a pharmaceutically active ingredient in a pharmaceutical composition in order to influence, in particular improve, qualitative properties of the pharmaceutical composition. Preferably, the auxiliaries and/or additives do not exert any pharmacological effect or, with regard to the intended treatment, no appreciable pharmacological effect or at least no undesirable pharmacological effect.

In the context of the present description, “polymer particles” means copolymers according to the invention in particle form, which may also contain other ingredients. The particles may be present in liquid form dispersed in a hydrophilic liquid or the particles may be present in solid form, either dispersed in a hydrophilic liquid or in the form of a powder. The size of the particles can be determined by visual methods, such as microscopy; for particle sizes in the nanoscale, light scattering or electron microscopy can be used. The shape of the polymer particles can be arbitrary, for example spherical, ellipsoidal or irregular. The polymer particles can also form aggregates of several primary particles. Preferably, the particles of copolymers according to the invention are in the form of nanoparticles. The particles may contain other components in addition to the copolymers, for example active ingredients or excipients or additives.

The terms “corpuscles” or “particles” are used synonymously in the context of the present description.

In the context of the present description, the term “nanoparticles” refers to particles whose diameter is less than 1 μm and which may be composed of one or more molecules. They are generally characterized by a very high surface-to-volume ratio and thus offer very high chemical reactivity. Nanoparticles can consist of copolymers according to the invention or contain other components in addition to these copolymers, such as active ingredients or excipients or additives.

The copolymers according to the invention can be present as linear polymers or they can also be branched copolymers. Linear copolymers are formed, for example, by consecutive hydrolysis of PEtOx, followed by partial oxidation to oxPEI and by reacylation to dPAOx. Branched copolymers are formed, for example, by partial oxidation of commercially available PEI, which is known to be branched, to oxPEI followed by re-functionalization, e.g., by reacylation to dPAOx.

The solubility of the copolymers according to the invention can be influenced by co-polymerization with suitable monomers and/or by functionalization. Such techniques are known to the skilled person.

The copolymers according to the invention can comprise a wide range of molar masses. Typical molar masses (Mₙ) range from 1,000 to 500,000 g/mol, in particular from 1,000 to 50,000 g/mol. These molar masses can be determined by ¹H NMR spectroscopy of the dissolved polymer. In particular, an analytical ultracentrifuge or chromatographic methods, such as size exclusion chromatography, can be used to determine the molar masses.

Preferred copolymers according to the invention have an average molecular weight (number average) in the range from 1,000 to 50,000 g/mol, in particular from 3,000 to 10,000 g/mol, determined by ¹H-NMR spectroscopy or by using an analytical ultracentrifuge. Preferably, these are linear copolymers. Branched copolymers according to the invention preferably have a higher average molar mass, for example an Mₙ in the range from 50,000 to 500,000 g/mol, in particular from 80,000 to 200,000 g/mol.

The molar proportion of structural units of the formula (I) in the copolymers according to the invention is 10 to 95 mol %, preferably 20 to 90 mol % and in particular 30 to 70 mol %, based on the total amount of structural units of the formulae (I), (II) and (III).

The molar proportion of structural units of the formula (II) in the copolymers according to the invention is 5 to 90 mol %, preferably 10 to 80 mol % and in particular 30 to 70 mol %, based on the total amount of structural units of the formulae (I), (II) and (III).

The molar proportion of structural units of the formula (III) in the copolymers according to the invention is 0 to 20 mol %, preferably 0 to 10 mol %, based on the total amount of structural units of the formulae (I), (II) and (III).

The molar fraction of structural units of the formula (IV) in the copolymers according to the invention is 10 to 95 mol %, preferably 20 to 90 mol % and in particular 30 to 70 mol %, based on the total amount of structural units of the formulae (IV), (V) and (VI).

The molar proportion of structural units of the formula (V) in the copolymers according to the invention is 5 to 90 mol %, preferably 10 to 80 mol % and in particular 30 to 70 mol %, based on the total amount of structural units of the formulae (IV), (V) and (VI).

The molar proportion of structural units of the formula (VI) in the copolymers according to the invention is 0 to 20 mol %, preferably 0 to 10 mol %, based on the total amount of structural units of the formulae (IV), (V) and (VI).

R¹ is a radical of the formula —CO—R² or of the formula —CO—NH—R² or of the formula —CH₂—CH(OH)—R¹², preferably a radical of the formula —CO—R².

R³, R⁴, R⁵, R⁷, R⁸, R⁹, R¹⁰ and R¹¹ independently of one another denote hydrogen, methyl, ethyl, propyl or butyl, preferably hydrogen, methyl or ethyl and in particular hydrogen.

R² is hydrogen, alkyl, cycloalkyl, aryl, aralkyl, —CₘH₂ₘ—X or —(CₙH₂ₙ—O)ₒ—(CₚH₂ₚ—O)_{q}—R⁶, preferably hydrogen, C₁-C₁₈-alkyl, cyclohexyl or phenyl, in particular C₁-C₁₈-alkyl, and very particularly C₁-C₁₄-alkyl.

R⁶ is hydrogen or C₁-C₆-alkyl, preferably hydrogen or methyl

R¹² is hydrogen, alkyl, alkenyl, cycloalkyl, aryl or aralkyl, preferably hydrogen, C₁-C₁₈-alkyl, C₂-C₁₈-alkenyl, cyclohexyl or phenyl, in particular hydrogen, C₁-C₆-alkyl or C₂-C₃-alkenyl.

m means an integer from 1 to 18, preferably from 2 to 12.

X is hydroxyl, alkoxy, carboxyl, carboxylic acid ester, sulfuric acid ester, sulfonic acid ester or carbamic acid ester, preferably hydroxyl or alkoxy

n and p independently of one another are integers from 2 to 4, where n is not equal to p. Preferably, n is 2 and p is 3.

o and q independently of one another are integers from 0 to 60, where at least one of o or q is not 0. Preferably, o and q are, independently of one another, 1 to 40, in particular 2 to 10.

The radicals R² and R¹² can denote alkyl. These are usually alkyl groups with one to twenty carbon atoms, which can be straight-chain or branched. Examples include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl or eicosyl. Methyl, ethyl and propyl are particularly preferred.

R¹² can be alkenyl. These are usually alkenyl groups with two to twenty carbon atoms, which may be straight-chain or branched. The double bond can be at any position in the chain, but preferably in the alpha position. Examples of alkenyl radicals are vinyl, allyl, butenyl, pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl or eicosenyl. Vinyl and allyl are particularly preferred.

The radicals R² and R¹² can denote cycloalkyl. These are usually cycloalkyl groups with five to six ring carbon atoms. Cyclohexyl is particularly preferred.

The radicals R² and R¹² can denote aryl. These are generally aromatic hydrocarbon radicals having five to ten ring carbon atoms. Preferred is phenyl.

The radicals R² and R¹² can denote aralkyl. These are usually aryl groups linked to the rest of the molecule through an alkylene group. Preferred is benzyl.

Radical X can mean alkoxy. These are usually C₁-C₆-alkoxy groups. Preferred is ethoxy and especially methoxy.

Radical X can mean a carboxylic acid ester (—COOR), sulfonic acid ester (—SO₃R), sulfuric acid ester (—SO₄R) or carbamic acid ester (—NR′COOR or —OCONRR′) (R and R′ are each monovalent organic radicals). These are usually esters of carboxylic, sulfonic, sulfuric or carbamic acids with aliphatic alcohols, in particular with aliphatic C₁-C₆-alcohols. Ethyl and in particular methyl esters are preferred.

Preferred are copolymers containing 20 to 90 mol % of structural units of the formula (I), 10 to 80 mol % of structural units of the formula (II) and 0 to 20 mol % of structural units of the formula (III).

Also preferred are copolymers in which R¹ is a radical of the formula —CO—R².

Also preferred are copolymers in which R² is C₁-C₁₈-alkyl, in particular C₁-C₆-alkyl, and very preferably C₁-C₂-alkyl.

Further preferred are copolymers in which R² is C₃-C₁₈-alkyl, in particular C₇-C₁₂-alkyl.

A further group of preferred copolymers is characterized in that R² is C₁-C₁₈-alkyl and R³, R⁴, R⁵, R⁷, R⁸, R⁹, R¹⁰ and R¹¹ are hydrogen.

Furthermore, copolymers in which R⁶ is hydrogen or methyl are preferred.

Further preferred copolymers are characterized in that R² is C₁-C₁₈-alkyl, cycloalkyl or phenyl.

Further preferred copolymers are characterized in that n=2 and p=3.

Particularly preferred copolymers are water-soluble.

The copolymers of the invention may consist of the structural units of the formulae (I), (II) and optionally (III) or of the structural units of the formulae (IV), (V) and optionally (VI) or may additionally contain further structural units derived from monomers which can be copolymerized with monomers used in the preparation of polyalkyleneimines or polyoxazolines. The proportion of such further structural units, based on the total mass of the copolymer, is generally up to 25 mol %. These further structural units can be randomly distributed or arranged in the form of blocks in the copolymer.

Preferred copolymers according to the invention are characterized in that they contain at least 90 mol %, in particular at least 95 mol %, based on their total mass, of structural units corresponding to formula (I), formula (II) and optionally formula (III) or formula (IV), formula (V) and optionally formula (VI).

The copolymers according to the invention have end groups that are typically formed during the preparation of poly(oxazolines) or of poly(alkylenimines). These end groups can be modified by functionalization. The techniques required for this are known to the skilled person.

Examples of omega end groups of the polyoxazoline or polyoxazine starting materials of the copolymers according to the invention are halogen atoms, such as fluorine, chlorine, bromine or iodine; or azide groups —N₃; or fluoro(alkyl)sulfonic ester groups, such as the nonaflat group —OSO₂C₄F₉, the trifluoromethane sulfonate group OSO₂CF₃ or the fluorosulfonate group —OSO₂F; or aryl or alkyl sulfonic acid groups, such as the tosyl group CH₃—C₆H₄—SO₂— or the mesyl group CH₃—SO₂—; the unsubstituted, mono- or di-substituted amino group NH₂, —NHR or —NR₂ (where R=monovalent organic radical), the hydroxyl group OH, the thiol group —SH, or the ester group —OCOR, the thioester group SCOR; the phthalimide group or the cyano group —CN, as well as further functional groups which can be obtained by modification of these end groups. The copolymers according to the invention contain these residues as end groups or may contain the hydrolysis and/or oxidation products of these residues as end groups.

Copolymers according to the invention can be covalently linked to other active or effect substances via the end groups.

The copolymers according to the invention can be prepared—as explained above—by partial oxidation of polyalkyleneimines and by re-functionalization of the oxidized product by reaction with an epoxide, isocyanate or an activated acyl derivative, in particular with an activated ester or acyl halide.

The oxidation is preferably carried out in solution, in particular in aqueous or alcohol-aqueous solution. Oxidants known per se can be used as oxidizing agents. Examples include per compounds, hypochlorites, chlorine or oxygen, in particular hydrogen peroxide.

Preferably, per-compounds are used. Examples are hydrogen peroxide, peracids, organic peroxides or organic hydroperoxides, in particular hydrogen peroxide.

Preferred processes are those in which the oxidizing agent used in step i) is hydrogen peroxide.

The amount of oxidizing agent is selected to give the desired proportion of oxidized structural units in the polymer backbone.

The reaction temperature is generally between 10 and 80° C., particularly in the range of 20 to 40° C.

The reaction time for oxidation is generally between 5 minutes and 5 days.

Re-functionalization of the oxidized product is carried out by reaction with an acyl derivative of formula (VII) described above or with an isocyanate of formula (VIII) described above or with an epoxide of formula (IX) described above.

Examples of suitable acyl derivatives are acyl halides, carboxylic acid anhydrides or carboxylic acids activated by means of known coupling reagents, for example N-hydroxysuccinimide esters (NHS esters), dicyclohexylcarbodiimide esters (DCC esters) or 1-ethyl-3-(3-dimethylaminopropyl)carbodiimide esters (EDC esters).

Examples of suitable isocyanates are monoalkyl isocyanates, such as methane isocyanate or ethane isocyanate, cyclohexyl isocyanate or phenyl isocyanate.

Examples of suitable epoxides are ethylene oxide, propylene oxide, 1,2-epoxybut-3-ene or 1,2-epoxypent-4-ene.

The reaction temperature is generally between 10 and 80° C., in particular in the range of 20 to 40° C.

The reaction time for the re-functionalization is generally between 5 minutes and 5 days, in particular between 12 and 48 hours.

Preferably, the poly(alkylene imines) used are copolymers obtained by alkaline or, in particular, acid hydrolysis of poly-(2-oxazolines), especially poly(2-alkyl-2-oxazoline)s. These copolymers are linear and are used as well-defined starting materials derived from polymers that can be obtained by CROP of commercially available monomers.

Poly(oxazolines) are well known compounds. These are usually prepared by cationic ring-opening polymerization of 2-oxazolines in solution and in the presence of an initiator. Examples of initiators include electrophiles, such as esters of aromatic sulfonic acid salts or esters of aliphatic sulfonic acids or carboxylic acids, or aromatic halogen compounds. Multi-functional electrophiles can also be used as initiators.

In addition to linear poly(oxazoline)s, branched or star-shaped molecules can also be formed. Examples of preferred initiators are esters of arylsulfonic acids, such as methyl tosylate, esters of alkanesulfonic acids, such as methyl triflate, or mono- or dibromomethylbenzene. The polymerization is usually carried out in a polar aprotic solvent, for example in acetonitrile.

The oxazolines used for the preparation of the poly(oxazolines) according to the invention are 2-oxazolines (4,5-dihydrooxazoles) with a C═N double bond between the carbon atom 2 and the nitrogen atom. These may be substituted at the 2-, 4- and/or 5-carbon atom, preferably at the 2-carbon atom.

Preferably, 2-oxazolines are used which contain a substituent at the 2-position. Examples of such substituents are methyl or ethyl.

In addition to the 2-oxazolines, other monomers copolymerizable with 2-oxazolines can be used in the preparation of the poly(oxazolines) used as starting materials according to the invention.

Instead of oxazolines, 2-oxazines can also be used to prepare homologous poly(oxazines).

The hydrolysis of poly(oxazolines) is preferably carried out in solution, in particular in aqueous or alcoholic-aqueous solution. Inorganic or organic acids can be used as acids. Preferably, mineral acids are used. Examples are hydrochloric acid, sulfuric acid or nitric acid, preferably hydrochloric acid. Suitable bases include alkali hydroxides, such as sodium hydroxide or potassium hydroxide.

The reaction temperature is generally between 20 and 180° C., in particular in the range of 70 to 130° C.

The reaction time during hydrolysis is generally between 5 minutes and 24 hours.

Preference is therefore given to processes in which the polyalkyleneimine used in step i) is obtained by hydrolysis, in particular by acid hydrolysis of a poly(oxazoline).

The copolymers according to the invention can be used for the preparation of formulations containing pharmaceutical or agrochemical active ingredients.

As a result of their good biodegradability, they are ideally suited for applications in the field of active ingredient delivery. These uses are also within the scope of the present invention.

The copolymers of the invention can be water-soluble or non-water-soluble depending on their functionalization. Copolymers functionalized with formyl, acetyl-propionyl groups or butionyl are generally water-soluble. Copoylmers functionalized with longer alkanoyl chains, on the other hand, are not water-soluble.

Non-water-soluble copolymers of the invention can be present dispersed in hydrophilic liquids, for example as emulsions or as suspensions.

Preferably, the copolymers according to the invention are in the form of particles, in particular in the form of nanoparticles.

The invention therefore also relates to particles, in particular nanoparticles containing the copolymers described above.

Preferred are nanoparticles whose mean diameter D50 is less than 1 μm, preferably 20 to 500 nm.

Particles containing one or more pharmaceutical or agrochemical active ingredients are particularly preferred.

Particularly preferred particles contain, in addition to the copolymer of the invention, at least one pharmaceutical active ingredient and suitable auxiliaries and additives.

The particles may be present as a powder in solid form or they may be present dispersed in hydrophilic solvents, the particles being present in the dispersing medium in liquid form or, in particular, in solid form.

Preferably, the particles form a disperse phase in a liquid containing water and/or water-miscible compounds.

The proportion of particles in a dispersion can cover a wide range. Typically, the proportion of particles in the dispersion medium is 0.5 to 20 wt %, preferably 1 to 5 wt %.

The particles according to the invention can be prepared by precipitation, preferably by nanoprecipitation. For this purpose, the copolymers according to the invention, which are little or not hydrophilic due to the presence of hydrophobic groups, are dissolved in a water-miscible solvent, such as acetone. This solution is dripped into a hydrophilic dispersing medium. This is preferably done with vigorous stirring. This can promote the production of smaller particles. The copolymer is deposited in the dispersing medium in finely divided form.

Alternatively, the particles according to the invention can also be produced by emulsification, preferably by nanoemulsion. For this purpose, the copolymers according to the invention, which are little or not hydrophilic due to the presence of hydrophobic groups, are dissolved in a water-immiscible solvent, such as dichloromethane or ethyl acetate. This solution is combined with a hydrophilic dispersing medium, preferably forming two liquid phases. Subsequently, this mixture is emulsified by energy input, preferably by sonication with ultrasound.

In addition to the copolymer according to the invention, one or more active ingredients and/or one or more auxiliaries and additives may be present during dispersion thereof in the dispersing medium. Alternatively, these active ingredients and/or auxiliary substances and additives can be added after the copolymer has been dispersed in the hydrophilic liquid.

The separation of the polymer particles from the hydrophilic liquid can take place in different ways. Examples include centrifugation, ultrafiltration or dialysis.

The polymer dispersion produced according to the invention can be further purified after production. Common methods include purification by dialysis, by ultrafiltration, by filtration, or by centrifugation.

The following examples illustrate the invention without limiting it.

### MATERIALS

All chemicals and solvents were purchased from commercial suppliers and used without further purification unless otherwise stated. 2-Ethyl-2-oxazoline (EtOx, 99+%), triethylamine (NEt₃, 99.7%), and EtOx were purchased from Acros Organics. 2-Ethyl-2-oxazoline was dried over calcium hydride and distilled under argon atmosphere. Methyl tosylate (MeOTs, 98%), n-decanoyl chloride (98%), and proteinase K were obtained from Sigma Aldrich. Methyl tosylate was dried over barium oxide and distilled under argon atmosphere. Hydrochloric acid (37%) was obtained from Fisher Chemicals. Aqueous hydrogen peroxide solution (30% w/w) was obtained from Carl Roth. Acetyl chloride (approximately 90%) was obtained from Merck Schuchardt. Propionyl chloride (>98.0%), n-butyryl chloride (>98.0%), valeroyl chloride (>98.0%), n-hexanoyl chloride (>98.0%), n-heptanoyl chloride (>98.0%), n-octanoyl chloride (>99.0%), and n-nonanoyl chloride (>95.0%) were purchased from Tokyo Chemical Industry (TCI). Amberlite IRA-67 was obtained from Merck and was washed several times with deionized water before use. N, N-dimethylformamide (DMF) and acetonitrile were dried in a solvent purification system (MB-SPS-800 from M Braun). Phosphate buffered saline (PBS) was obtained from Biowest.

Performance of Measurements

Proton (¹H) nuclear magnetic resonance (NMR) spectra were measured on a Bruker AC 300 MHz or a Bruker AC 400 MHz spectrometer. Correlation spectroscopic (COSY) NMR, heteronuclear single quantum correlation spectroscopic (HSQC) NMR, heteronuclear multiple bond correlation (HMBC) NMR spectra, and DOSY NMR spectra were recorded on a Bruker AC 400 MHz spectrometer. Measurements were performed at room temperature using either D₂O, d₄-methanol, or deuterated chloroform as solvents. Chemical shifts (6) are reported in parts per million (ppm) relative to the remaining non-deuterated solvent resonance signal. Infrared (IR) spectroscopy was performed on a Shimadzu IRAffinity-1 CE system equipped with a Quest ATR single reflectance diamond crystal cuvette for extended range measurements.

Size exclusion chromatography (SEC) was performed using two different setups. Measurements in N,N-dimethylacetamide (DMAc) were performed using an Agilent 1200-series system equipped with a PSS degasser, a G1310A pump, a G1329A autosampler, a Techlab oven, a G1362A refractive index detector (RID), and a PSS GRAM-guard/30/1000 Å column (10 μm particle size). DMAc containing 0.21 wt % LiCl was used as the eluent. The flow rate was 1 ml min⁻¹ and the oven temperature was 40° C. Polystyrene (PS) standards ranging from 400 to 1,000,000 g mol⁻¹ were used to calculate molar masses. Measurements in chloroform were performed using a Shimadzu system (Shimadzu Corp., Kyoto, Japan) equipped with an SCL-10A VP system controller, a SIL-10AD VP autosampler, an LC-10AD VP pump, an RID-10A RI detector, a CTO-10A VP oven, and a PSS SDV guard/lin S column (5 mm particle size). A mixture of chloroform/isopropanol/triethylamine (94/2/4 vol %) was used as eluent. The flow rate was 1 ml min⁻¹ and the oven temperature was 40° C. PS standards from 400 to 100,000 g mol-1 were used to calibrate the system.

Thermogravimetric analysis (TGA) was performed using a Netzsch TG 209 F1 Iris from 20 to 580° C. at a heating rate of 20 K min⁻¹ under N2 atmosphere. Decomposition temperatures (T_{d}) were determined at 95% of the original mass.

Differential scanning calorimetry (DSC) measurements were performed using a Netzsch DSC 204 F1 Phoenix under N2 atmosphere from −100 to 160° C., −100 to 150° C., −190 to 100° C., and −190 to 140° C., respectively. Three heating runs were recorded for each measurement. The first and second runs were performed at a heating rate of 20 K min⁻¹ and the third run was performed at a heating rate of 10 K min⁻¹. The cooling rate between the first and second runs was set to 20 K min⁻¹ and between the second and third runs to 10 K min⁻¹. Glass transition temperatures (T_{g}, inflection points) and melting temperatures (Tₘ) were determined from the third heating run. Thermograms were analyzed using Netzsch Proteus Thermal Analysis 4.6.1 software, which applies the smoothing option to analyze the T_{g} value when necessary.

### General Synthesis Methods

### Synthesis of poly(2-ethyl-2-oxazoline), PEtOx

PEtOx was synthesized by cationic ring opening polymerization (CROP) of EtOx. In a scale-up batch method, MeOTs (124 g, 0.665 mol) and EtOx (3965 g, 40.00 mol, 60.2 equiv.) were dissolved under argon atmosphere in dry MeCN (5860 ml) in a 10 L Normag reactor to achieve a monomer-to-initiator ratio [M]:[I] of 60:1. After a reaction time of 6.5 h under reflux conditions, the polymerization was terminated with 270 ml of deionized water. After removal of aliquots for determination of monomer conversion (99.7%) by ¹H NMR spectroscopy, the solvent was removed under reduced pressure, the residue was dissolved in dichloromethane (20 L) and washed with saturated aqueous sodium hydrogen carbonate solution (10 L) and aqueous sodium chloride solution (2×10LI). The organic phase was dried over a mixture of sodium sulfate (15 kg) and magnesium sulfate (4 kg) and the solvent was removed under reduced pressure. The product was finally dried in vacuo for 14 days (yield: 3848 g) and analyzed by ¹H NMR spectroscopy (300 MHz, D₂O) and SEC. M_{n,theor.}=6000 g mol-1; M_{n,NMR}=6300 g mol⁻¹; DP=60.

### Synthesis of Linear Poly(Ethyleneimine), PEI

The synthesis of PEI was performed by an adapted procedure based on previously published methods (Van Kuringen, H. P.; Lenoir, J.; Adriaens, E.; Bender, J.; De Geest, B. G.; Hoogenboom, R. Partial hydrolysis of poly(2-ethyl-2-oxazoline) and potential implications for biomedical applications? Macromol. Biosci. 2012, 12, 1114-1123; Tauhardt, L.; Kempe, K.; Knop, K.; Altuntaş, E.; Jager, M.; Schubert, S.; Fischer, D.; Schubert, U. S. Linear polyethyleneimine: Optimized synthesis and characterization—On the way to “pharmagrade” batches. Macromol. Chem. Phys. 2011, 212, 1918-1924). PEtOx (80.0 g, 12.5 mmol) was dissolved in aqueous hydrochloric acid (6 M, 600 mL) and heated to 90° C. for 24 h. Volatiles were removed under reduced pressure and the residue was dissolved in deionized water (1600 mL). Aqueous NaOH (3 M, 300 mL) was added in portions to achieve a pH of 10, resulting in precipitation of the polymer. The polymer was then filtered off and purified by recrystallization in water (800 mL). PEI was obtained as a white solid (yield: 47.5 g).

¹H NMR (300 MHz, CD₃OD): degree of hydrolysis (DH)=99%.

### Synthesis of poly(ethyleneimine-stat-glycine), oxPEI

The synthesis of oxPEI was performed according to an adapted method of Englert et al. (Englert, C.; Hartlieb, M.; Bellstedt, P.; Kempe, K.; Yang, C.; Chu, S. K.; Ke, X.; Garcia, J. M.; Ono, R. J.; Fevre, M.; Wojtecki, R. J.; Schubert, U. S.; Yang, Y. Y.; Hedrick, J. L. Enhancing the biocompatibility and biodegradability of linear poly(ethylene imine) through controlled oxidation. Macromolecules 2015, 48, 7420-7427). PEI (45.0 g, 17.0 mmol) was dissolved in methanol (1100 ml) with stirring and aqueous hydrogen peroxide solution (72 ml, 30% w/w, 0.7 equiv. per amine unit) was added dropwise. After stirring at room temperature for 3 days, the solvent was removed under reduced pressure and the product was dried in vacuo at room temperature for 7 days and at 70° C. for 1 day. oxPEI was obtained as a brown solid (yield: 29.1 g).

¹H NMR (300 MHz, D₂O): degree of oxidation (DO)=54%.

### General Synthesis Procedure for poly(2-n-alkyl-2-oxazoline-stat-glycin)es, dPAOx

oxPEI was predried under vacuum for 2 h at 70° C. and then dissolved in dry DMF (6 ml per g polymer) under argon atmosphere. Triethylamine (4 equiv. per amine unit) was added, followed by dropwise addition of acyl chloride solutions (3 equiv. per amine unit) in dry DMF (6 mL per g polymer). During this process, the mixture was cooled in an ice bath. Additional dry DMF (6 mL per g of polymer) was used to rinse residues from the flask walls. After reaching room temperature, the reaction mixture was stirred for an additional 24 hours. Purification was adjusted depending on the solubility of the products. Details on the preparation of individual dPAOx can be found in the experimental section below.

Determination of the Degree of Hydrolysis

The degree of hydrolysis DH was calculated according to equation (1) from the integrals of the ¹H NMR spectra of PEI. Here, D means the integral of the methylene groups of the ethyleneimine units and A means the integral of the methyl groups of the remaining EtOx units.

$$DH = \frac{D}{D + \frac{4}{3} A} \cdot 100 \% \qquad ( 1 )$$

Determination of the Degree of Oxidation

The degree of oxidation DO was calculated from the integrals of the polymer backbone signals of the ¹H NMR spectra of oxPEI according to equation (2). Here, F means the integral of the methylene group of the glycine units, A means the integral of the methyl groups of the remaining EtOx units and D means the integral of the methylene groups of the ethyleneimine units.

$$DO = \frac{2 ( F - \frac{4}{3} A )}{( F - \frac{4}{3} A ) + D} \cdot 100 \% \qquad ( 2 )$$

Performance of Titration

Titrations for the determination of the remaining amino groups were carried out with an auto-mated Metrohm OMNIS Titrator equipped with a Metrohm Ecotrode plus pH electrode. All measurements were performed in a dynamic titration mode that adapted the titration speed to the change in pH during the titration. A typical measurement was performed as follows: The polymer was dissolved in deionized water to give a polymer solution of 10 mL with a concentration of 1 mg mL⁻¹. The polymer solution was acidified by adding a concentrated aqueous HCl solution dropwise to achieve a pH of 2. The solution was then titrated to a pH of 12 with stirring against aqueous 0.1 M sodium hydroxide solution. The equivalence points were determined from the first derivative of the titration curve.

Performance of Degradation Studies

For degradation under acidic conditions, the polymer (20 mg) was dissolved in 6 mol L⁻¹ HCl (2 ml) and stirred for 48 h at 90° C. The reaction mixture was neutralized with aqueous sodium hydroxide solution and the water was removed under reduced pressure.

For degradation under enzymatic conditions, dPMeOx (20 mg) and proteinase K (10 mg) were dissolved in PBS buffer solution and incubated at 37° C. for 30 days. Water was then removed under reduced pressure. Both products were analyzed by NMR spectroscopy.

### Preparation Example H1: Synthesis of poly(2-methyl-2-oxazoline-stat-glycine), dPMeOx

dPMeOx was prepared according to the general procedure using 3.2 g (1.0 mmol) oxPEI, 16 ml (11.6 g, 115 mmol, 4.1 equiv. per amine unit) triethylamine, and 6 ml (6.6 g, 84 mmol, 3.0 equiv. per amine unit) acetyl chloride. The reaction mixture was precipitated by direct immersion in ice-cold diethyl ether (about −80° C., 700 ml). The residue was dissolved in DMF (70 ml) and the precipitation was repeated twice. The crude product was dissolved in deionized water, Amberlite IRA-67 ion exchange resin was added and the mixture was stirred for 1.5 h at room temperature. Subsequently, Amberlite IRA-67 was filtered off and water was removed under reduced pressure. The crude product was dissolved in methanol and precipitated twice in ice-cold diethyl ether (about −80° C.). The product was dissolved in methanol and dried under reduced pressure. The residue was dissolved in deionized water and freeze-dried. To remove all remaining impurities, the product was dissolved in deionized water and stirred with Amberlite IRA-67 Ion Exchange Resin for an additional 4 h. Amberlite IRA-67 was filtered off and the product dried under reduced pressure. Dissolution in deionized water and freeze drying gave dPMeOx as a brown solid (yield: 1.9 g).

### Preparation Example H2: Synthesis of poly(2-ethyl-2-oxazoline-stat-glycine), dPEtOx

dPEtOx was prepared according to the general procedure using 3.2 g (1.0 mmol) oxPEI, 16 ml (11.6 g, 115 mmol, 3.8 equiv. per amine unit) triethylamine, and 7.5 ml (8.0 g, 86 mmol, 2.9 equiv. per amine unit) propionyl chloride. Triethylammonium chloride formed during the reaction was filtered off and the solution precipitated in ice-cold diethyl ether (1000 ml, −80° C.). The residue was dissolved in DMF (50 ml) and precipitated again in ice-cold diethyl ether (500 ml). The crude product was dissolved in deionized water, Amberlite IRA-67 ion exchange resin was added, and the mixture was stirred for 1.5 h. Subsequently, Amberlite IRA-67 was then filtered off and water was removed under reduced pressure. The residue was dissolved twice in methanol (30 ml) and precipitated in ice-cold diethyl ether (about −80° C.). The product was dissolved in methanol and dried under reduced pressure, dissolved in deionized water and freeze-dried. The product was redissolved in deionized water and stirred with Amberlite IRA-67 ion-exchange resin for 4 h. Amberlite IRA-67 was filtered off and water was removed under reduced pressure. The product was redissolved in deionized water and freeze-dried. dPEtOx was obtained as a brown solid (yield: 1.0 g).

### Preparation Example H3: Synthesis of poly(2-n-propyl-2-oxazoline-stat-glycine), dPPropOx

dPPropOx was prepared according to the general procedure using 3.2 g (1.0 mmol) oxPEI, 16 ml (11.6 g, 115 mmol, 3.8 equiv. per amine unit) triethylamine, and 8.5 ml (8.8 g, 82 mmol, 2.7 equiv. per amine unit) butyryl chloride. The precipitated triethylammonium salt was filtered off after the reaction and the filtrate was concentrated under reduced pressure. The residue was dissolved in chloroform (200 ml) and washed with saturated aqueous sodium hydrogen carbonate solution (3×500 ml) and aqueous sodium chloride solution (3×500 ml). The organic phase was dried over sodium sulfate, filtered and volatiles were removed under reduced pressure. Drying in vacuo overnight yielded the polymer as a brown, highly viscous liquid (yield: 6.7 g).

### Preparation Example H4: Synthesis of poly(2-n-butyl-2-oxazoline-stat-glycine), dPButOx

dPButOx was prepared according to the general procedure using 3.0 g (0.96 mmol) oxPEI, 15 ml (10.9 g, 108 mmol, 3.9 equiv. per amine unit) triethylamine, and 9.5 ml (9.7 g, 80 mmol, 2.9 equiv. per amine unit) valeroyl chloride. Triethylammonium chloride was removed by filtration. Volatiles were removed under reduced pressure, the residue was dissolved in chloroform (50 ml), and washed with saturated aqueous sodium hydrogen carbonate solution (3×20 ml) and aqueous sodium chloride solution (3×20 ml). The organic phase was dried over sodium sulfate, filitrated and concentrated under reduced pressure. The procedure was repeated twice until all triethylammonium salt impurities were removed. After removal of the solvent and drying in vacuo overnight, the product was obtained as a brown, highly viscous liquid (yield: 5.7 g).

### Preparation Example H5: Synthesis of poly(2-n-pentyl-2-oxazoline-stat-glycine), dPPentOx

dPPentOx was prepared according to the general procedure using 2.7 g (0.88 mmol) oxPEI, 13 ml (9.4 g, 93 mmol, 3.6 equiv. per amine) triethylamine, and 10 ml (9.6 g, 72 mmol, 2.8 equiv. per amine) hexanoyl chloride. Triethyl ammonium chloride was filtered off and volatiles were removed under reduced pressure. The crude product was dissolved in chloroform (100 ml) and washed with saturated aqueous sodium bicarbonate solution (3×40 ml) and aqueous sodium chloride solution (4×40 ml). To remove the remaining triethyl ammonium chloride and DMF impurities, the organic phase was diluted with chloroform (100 ml) and washed again with saturated aqueous sodium hydrogen carbonate solution (3×500 ml) and aqueous sodium chloride solution (3×500 ml). The organic phase was dried over sodium sulfate, filtered, and the solvent was removed under reduced pressure. After drying under vacuum overnight, the product was obtained as a brown, highly viscous liquid (yield: 6.5 g).

### Preparation Example H6: Synthesis of poly(2-n-hexyl-2-oxazoline-stat-glycine), dPHexOx

dPHexOx was prepared according to the general procedure using 2.1 g (0.88 mmol) oxPEI, 10.5 ml (7.6 g, 75 mmol, 3.8 equiv. per amine unit) triethylamine, and 8.5 ml (8.2 g, 55 mmol, 2.8 equiv. per amine unit) heptanoyl chloride. The precipitated triethylammonium salt was filtered off and the was filtrate concentrated under reduced pressure. The residue was dissolved in chloroform (200 ml) and washed with saturated aqueous sodium hydrogen carbonate solution (3×500 ml) and aqueous sodium chloride solution (3×500 ml). The organic phase was dried over sodium sulfate, filtered and solvent was removed under reduced pressure. After drying overnight, dPHexOx was obtained as a brown, highly viscous liquid (yield: 7.6 g).

### Preparation Example H7: Synthesis of poly(2-n-heptyl-2-oxazoline-stat-glycine), dPHeptOx

dPHeptOx was prepared according to the general procedure using 2.0 g (0.65 mmol) oxPEI, 10 ml (7.3 g, 72 mmol, 3.8 equiv. per amine unit) triethylamine, and 9 ml (8.6 g, 53 mmol, 2.8 equiv. per amine unit) octanoyl chloride. Triethyl ammonium chloride was filtered off and the filtrate was concentrated under reduced pressure. The residue was dissolved in chloroform (200 ml) and extracted with saturated aqueous sodium hydrogen carbonate solution (3×500 ml) and aqueous sodium chloride solution (3×500 ml). The organic phase was dried over sodium sulfate and filtered. Removal of the solvent and drying overnight gave the product as a brown, highly viscous liquid (yield: 7.4 g).

### Preparation Example H8: Synthesis of poly(2-n-octyl-2-oxazoline-stat-glycine), dPOctOx

dPOctOx was prepared according to the general procedure using 1.9 g (0.61 mmol) oxPEI, 9.5 ml (6.9 g, 68 mmol, 3.8 equiv. per amine unit) triethylamine, and 9.5 ml (8.9 g, 51 mmol, 2.8 equiv. per amine unit) nonanoyl chloride. Triethyl ammonium chloride formed during the reaction was filtered off and the filtrate was concentrated under reduced pressure. The residue was dissolved in chloroform (200 ml) and washed with saturated aqueous sodium hydrogen carbonate solution (3×500 ml) and aqueous sodium chloride solution (3×500 ml). The organic phase was dried over sodium sulfate, filtered, and the solvent was removed under reduced pressure. After drying overnight, the product was obtained as a brown, highly viscous liquid (yield: 7.5 g).

### Preparation Example H9: Synthesis of poly(2-n-nonyl-2-oxazoline-stat-glycine), dPNonOx

dPNonOx was prepared according to the general procedure using 1.8 g (0.58 mmol) oxPEI, 9 ml (6.5 g, 65 mmol, 3.8 equiv. per amine unit) triethylamine, and 10 ml (9.2 g, 48 mmol, 2.8 equiv. per amine unit) decanoyl chloride. Precipitated triethylammonium chloride was removed by filtration and volatiles were removed under reduced pressure. The crude product was dissolved in chloroform (200 ml) and extracted with saturated aqueous sodium hydrogen carbonate solution (3×500 ml) and aqueous sodium chloride solution (3×500 ml). The organic phase was dried over sodium sulfate and filtered. After removal of the solvent under reduced pressure and drying under vacuum overnight, the product was obtained as a brown, highly viscous liquid (yield: 6.7 g).

### Example C1: Characterization of the Polymers by ¹H-NMR Spectroscopy

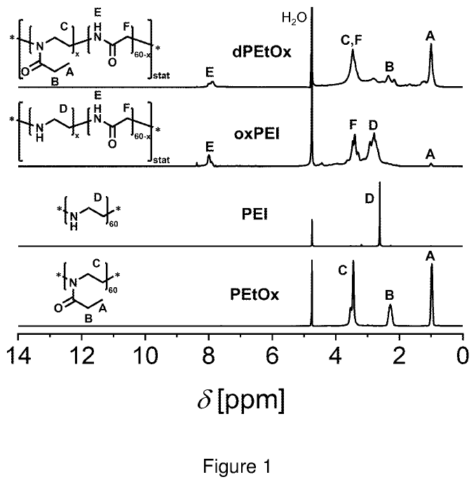

The first step towards a dPAOx library was to synthesize a substantial amount of PEtOx as a well-defined starting material via CROP (compare General Synthesis Methods, Synthesis of PEtOx). To this end, a synthesis protocol was developed in a 10 L Normag reactor that yielded nearly 4 kg of PEtOx with a degree of polymerization (DP) of 60 and a narrow dispersity (D) of 1.14, as determined by SEC in DMAc. Since CROP was terminated by addition of water, the resulting PEtOx contained two isomeric end groups resulting from nucleophilic attack on the 2- or 5-positions of the oxazoline ring, but in both cases this resulted in hydroxyl end groups upon hydrolysis to linear poly(ethyleneimine) (PEI). The hydrolysis was carried out under acidic conditions (see general synthesis methods, synthesis of PEI). To obtain complete hydrolysis, the reaction was carried out overnight with an excess of 6 M HCl. The successful synthesis was confirmed by the ¹H NMR spectrum (compare FIG. 1), which clearly showed the disappearance of the signals assigned to the ethyl substituents of PEtOx. Moreover, a clear high-field shift of the backbone signal (compare C vs. D in FIG. 1) confirmed the formation of PEI. The degree of hydrolysis (DH) was determined to be 99%, calculated by the ratio of the integrals in the ¹H NMR spectrum (compare general synthetic methods, synthesis and characterization of dPAOx, equation (1)).

FIG. 1 shows ¹H NMR spectra (300 MHz, 300 K, D₂O or MeOD) of PEtOx, PEI, oxPEI, and dPEtOx and the assignment of the signals to the schematic representations of the structures.

Next, PEI was prepared by oxidation of PEtOx using hydrogen peroxide as oxidant. The oxidation occurred in the polymer backbone and thus backbone amide groups were formed in a statistically distributed manner. The structure of the resulting oxPEI corresponds to the repeating unit of poly(glycine) adjacent to unaffected ethyleneimine units. Therefore, the polymer can also be referred to as a poly(ethyleneimine-stat-glycine) copolymer. With the aim of generating 50% of the amino groups by oxidation in PEI, 0.7 equivalents of hydrogen peroxide per amino group were used. The degree of oxidation (DO), determined by the integral ratio in the ¹H NMR spectrum as 54% (compare General Methods of Synthesis, Synthesis and Characterization of dPAOx, Eq. (2)), confirmed the successful synthesis. The methylene group signals assigned to the ethyleneimine (D) and glycine repeating units (F) occurred in close proximity in the ¹H NMR spectrum and partially overlapped each other. Coupling of these signals in the HMBC NMR spectrum confirmed the random distribution of the two different repeating units within the polymer. The NH proton signal E indicated the formation of an amide group, which confirmed the presence of glycine units as well.

Since the remaining amino groups can be further functionalized, the resulting oxPEI provided the platform for the synthesis of various degradable polymers. Here, subsequent reacylation with a homologous series of aliphatic acyl chlorides from acetyl chloride to n-decanoyl chloride was applied to reintroduce amide units equivalent to the N-acylethylenimine structures in PAOx. The resulting polymer structures resemble PAOx with additional, randomly distributed poly(glycine) units integrated into the polymer backbone. Therefore, they can also be considered as poly(2-n-alkyl-2-oxazoline-stat-glycine) copolymers or as degradable poly(2-n-alkyl-2-oxazoline) analogs due to the degradability of the glycine unit. Thus, the synthetic approach described allowed the preparation of a dPAOx library with the same chain length and DO, using only EtOx as a commercially available monomer.

Characterization of the purified dPAOx by ¹H NMR spectroscopy indicated a decrease in the signals attributed to the PEI repeating units, while signals attributed to the alkyl side chains confirmed their conversion to the corresponding N-acylethylenimine structures. As illustrated in FIG. 1 for dPEtOx, the corresponding signals (A and B) occurred at the same chemical shifts as in the non-degradable PEtOx starting material. The assignments were verified by COSY NMR, HSQC NMR, and HMBC NMR measurements.

### Example C2: Characterization of the Polymers by IR-Spectroscopy

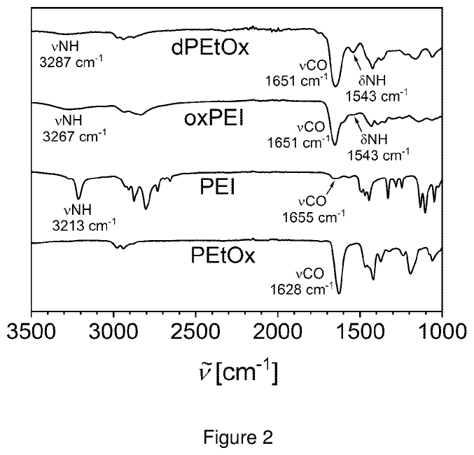

Further structural evidence was obtained by IR spectroscopy. FIG. 2 shows ATR-IR spectra of PEtOx, PEI, oxPEI, and dPEtOx in the range of wavenumbers from 1000 to 3500 cm⁻¹ including assignment of the major bands. The IR spectroscopy of PEtOx, PEI, poly(glycine) as well as oxPEI was previously described in the literature, which allowed easy assignment of vibrational bands. The band at 3213 cm⁻¹ in the PEI spectrum, assigned to the NH vibration of the amino group, was not observed for PEtOx but appeared after hydrolysis. The band decreased upon oxidation to oxPEI and almost disappeared after the following re-acylation step to dPEtOx, indicating almost complete functionalization of the amino groups. The vibrational band at 1628 cm⁻¹ in the PEtOx spectrum can be attributed to the amide I band, which is mainly due to the carbonyl valence vibration. The band disappeared almost completely during hydrolysis to PEI due to cleavage of the side chain carrying carbonyl groups. During oxidation to oxPEI and subsequent reacylation to dPEtOx, amide groups were reintroduced, leading to an increase in the carbonyl vibrational band. The amide II band at 1543 cm⁻¹, mainly caused by the NH bond deformation vibration, was not observed in PEtOx, which had only tertiary amide groups without NH bonds, showing the structural difference between PEtOx and dPEtOx. Signals of carboxylic acid derivatives due to possible degradation products are expected at about 1710 cm⁻¹. However, such signals could not be observed in the spectra of oxPEI or dPEtOx.

### Example C3: Characterization of the Polymers by SEC

SEC analyses were limited due to solubility changes in the synthetic pathway as well as possible interactions of some polymers with the column material. However, all polymers dissolved in both CHCl₃ and DMAc, with the exception of PEI, which was not soluble in these SEC solvents, and dPMeOx, which was soluble only in DMAc (compare Table 1).

In agreement with the theoretically expected molar masses, the signal of PEtOx appeared at the lowest elution volume in the polar eluent DMAc, while the hydrodynamic volume of oxPEI decreased significantly. Reacylation to dPEtOx shifted its signal to an intermediate elution volume and corresponding molar mass. However, comparison of the SEC elugrams of all dPAOx clearly indicated that significant changes in hydrophilicity due to increasing side-chain length should be considered, as these affected the hydrodynamic volumes of the polymers. This was particularly evident from the apparent higher molar mass of dPMeOx compared to dPEtOx, which can be attributed to the relative method used to determine the molar mass of SEC.

The increased hydrophobicity of dPAOx with longer side chains was indicated by a comparison of their SEC elugrams in the hydrophobic eluent CHCl₃. Their signals shifted toward lower elution volumes with increasing side chain length. This is consistent with the trend expected for the theoretical molecular masses due to increased lipophilicity and thus increasing hydrodynamic volume within the homologous series. Nevertheless, the discrepancy between the Mₙ values determined by SEC and the theoretical molecular masses increased with side-chain length, indicating an increasing difference between the hydrodynamic volumes of the dPAOx and SEC standards previously reported for PAOx.

TABLE 1
molar masses Mₙ, dispersity values Ð and thermal properties of PEtOx, PEI, oxPEI and dPAOx.

| | Mₙ | SEC, CHCl₃ | | SEC, DMAc | | thermal properties | | |
|---|---|---|---|---|---|---|---|---|
| | theor.^{a} | Mₙ ^{b} | | Mₙ ^{c} | | T_{d} ^{d} | T_{g} ^{e} | Tₘ ^{f} |
| Polymer | [g/mol] | [g/mol] | Ð ^{b} | [g/mol] | Ð ^{c} | [° C.] | [° C.] | [° C.] |
| PEtOx | 6000 | 4000 | 1.29 | 10,900 | 1.14 | 351 | 54 | — |
| PEI | 2600 | — | — | — | — | 317 | — | 62 |
| oxPEI | 3100 | 330 | 1.75 | 1570 | 1.46 | 155 | 16 | — |
| dPMeOx | 4200 | — | — | 5420 | 3.35 | 170 | 105 | — |
| dPEtOx | 4600 | 470 | 1.95 | 3360 | 1.78 | 196 | 75 | — |
| dPPropOx | 5000 | 650 | 1.95 | 2880 | 1.77 | 154 | −24 | — |
| dPButOx | 5400 | 680 | 1.93 | 2560 | 1.54 | 175 | −36 | — |
| dPPentOx | 5800 | 830 | 1.79 | 1800 | 1.97 | 173 | −52 | — |
| dPHexOx | 6100 | 750 | 1.13 | 1850 | 2.05 | 194 | −71 | — |
| dPHeptOx | 6500 | 760 | 2.18 | 1920 | 1.85 | 194 | — | 9 |
| dPOctOx | 6900 | 1060 | 1.93 | 2020 | 1.93 | 200 | — | 18 |
| dPNonOx | 7300 | 890 | 2.20 | 2060 | 1.78 | 197 | — | 28 |

^{a}Received by calculation with theoretical monomer units.
^{b} Determined by SEC in CHCl₃ (2 vol % isopropanol, 4 vol % triethylamine, PS calibration, RI detection).
^{c} Determined by SEC in DMAc (0.21 wt % LiCl, PS calibration, RI detection).
^{d} Decomposition temperature; determined by TGA at 95% of the original mass.
^{e} Glass transition temperature; determined by DSC using the third heating curve at 10K min⁻¹; inflection points are determined as T_{g} values.
^{f} Melting temperature; determined by DSC using the third heating curve at 10K min⁻¹.

Among the synthesized dPAOx, only the polymers with the shortest side chains, namely dPMeOx and dPEtOx, were sufficiently hydrophilic to be soluble in water at room temperature. In contrast, degradable poly(2-n-butyl-2-oxazoline) analogs (dPButOx) and longer side chain analogs were hydrophobic and could only be dissolved in organic solvents. The degradable poly(2-n-propyl-2-oxazoline) analog (dPPropOx) showed intermediate solubility behavior. Only small amounts could be dissolved in water, which allowed the titration of amino groups in aqueous solution (see below). Nondegradable PAOx exhibit similar solubility characteristics. However, PEtOx and poly(2-n-propyl-2-oxazoline) (PPropOx) exhibit a lower critical solution temperature (LCST) in water, whereas this was not observed for dPEtOx or dPPropOx, possibly due to the formation of additional hydrogen bonds that can be formed by the amide hydrogen of the glycine moiety.

### Example C4: Characterization of the Polymers by Titration

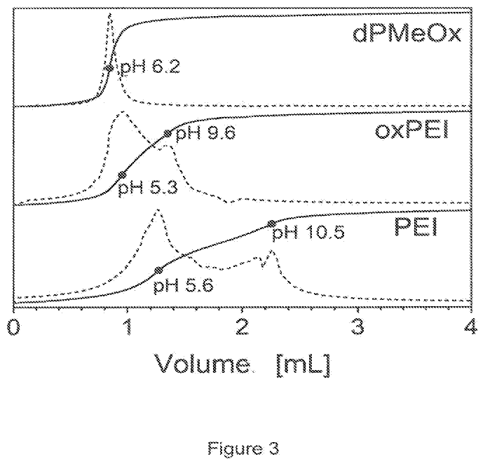

Titrations in aqueous solution were performed to determine the number of amino groups in the polymer backbone of PEI, oxPEI, and the water-soluble dPAOx, namely dPMeOx, dPEtOx, and dPPropOx. Although the titration of amino groups allowed a qualitative evaluation, an accurate quantitative analysis was not performed due to water residues in PEI and oxPEI that would affect the results. An overlay of the titration curves of PEI, oxPEI and dPMeOx is shown as an example in FIG. 3. FIG. 3 shows titration curves of PEI, oxPEI and dPMeOx (1 mg mL⁻¹) against 0.1 M NaOH and their first derivatives. The polymer solutions were acidified with concentrated HCl before titration. The individual curves are superimposed vertically for clarity and the corresponding pH values of the equivalence points are shown.

FIG. 3 shows the evolution within the synthesis sequence. Acidification of the aqueous polymer solutions with concentrated HCl prior to the titrations resulted in the appearance of two equivalence points (EP) for amino group-containing polymers when titrated with dilute sodium hydroxide solution. The first EP corresponds to the neutralization of the excess HCl, while the second EP refers to the neutralization of the amino groups. The oxidation of PEI to oxPEI converted 54% of the amino units to amide units of the poly(glycine) units. The decreased number of amino groups was evident in the decreased distance between the two EPs during titration.

Only one EP was observed in the titration curves of dPMeOx and dPPropOx. This was due to the neutralization of HCl alone and confirmed the complete functionalization of the amino groups. Two EPs still appeared in the titration curve of dPEtOx, revealing incomplete reacylation. However, their proximity indicated that only a small number of amino groups remained, consistent with observations from IR spectroscopy.

### Example C5: Characterization of the Polymers by TGA and DSC

The thermal properties of the polymers were investigated using thermogravimetric analysis (TGA) and differential scanning calorimetry (DSC).

The dPAOx showed good thermal stability up to temperatures above 100° C. However, they are not as stable as their non-degradable PAOx analogues, which exhibit degradation temperatures (T_{d}) up to above 300° C. The lower thermal stability of dPAOx may be attributed to the presence of additional degradable amide groups in the backbone.

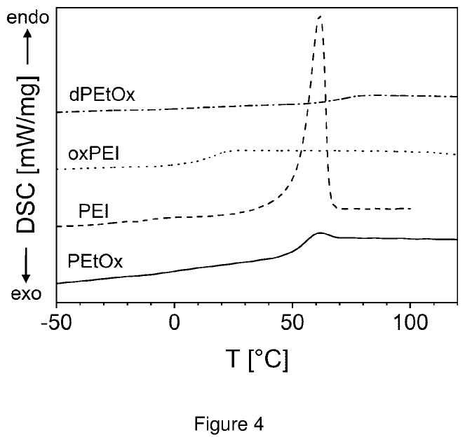

FIG. 4 shows the DSC thermograms of PEtOx, PEI, oxPEI, and dPEtOx (N2, third heating curve, 10 K min⁻¹). The individual thermograms are superimposed vertically for clarity.

FIG. 5 shows the DSC thermograms of different dPAOx (N2, third heating run, 10 K min⁻¹). Again, the individual thermograms are superimposed vertically for better visualization. In the figure, the DSC thermograms of the C₁-C₉-alkyl-substituted derivatives of dPAOx (dPMeOx-dPNonOx) are shown.

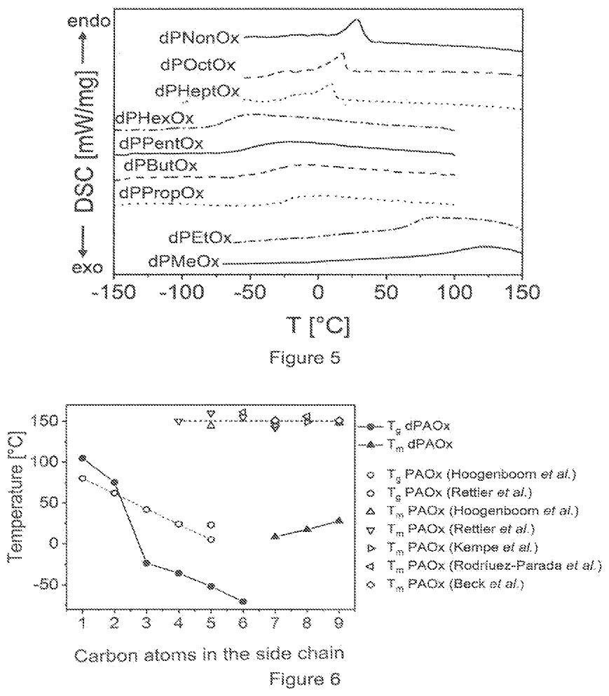

FIG. 6 shows glass transition temperatures and melting temperatures of dPAOx compared with glass transition temperatures and melting temperatures of non-degradable PAOx from literature. Glass transitions were determined from inflection points. Data from the literature were taken from the following publications: Hoogenboom, R.; Fijten, M. W. M.; Thijs, H. M. L.; van Lankvelt, B. M.; Schubert, U. S. Microwave-assisted synthesis and properties of a series of poly(2-alkyl-2-oxazoline)s. Des. Monomers Polym. 2005, 8, 659-671.
Rettler, E. F. J.; Kranenburg, J. M.; Lambermont-Thijs, H. M. L.; Hoogenboom, R.; Schubert, U. S. Thermal, mechanical, and surface properties of poly(2-N-alkyl-2-oxazoline)s. Macromol. Chem. Phys. 2010, 211, 2443-2448.
Kempe, K.; Lobert, M.; Hoogenboom, R.; Schubert, U. S. Synthesis and characterization of a series of diverse poly(2-oxazoline)s. J. Polym. Sci., Part A: Polym. Chem. 2009, 47, 3829-3838.
Beck, M.; Birnbrich, P.; Eicken, U.; Fischer, H.; Fristad, W. E.; Hase, B.; Krause, H.-J. Polyoxazolines on a lipid chemical basis. Angew. Makromol. Chem. 1994, 223, 217-233.
Rodríguez-Parada, J. M.; Kaku, M.; Sogah, D. Y. Monolayers and Langmuir-Blodgett films of poly(AT-acylethylenimines) with hydrocarbon and fluorocarbon side chains. Macromolecules 1994, 27, 1571-1577.

An overlay of the DSC thermograms of PEtOx, PEI, oxPEI and dPEtOx in FIG. 4 shows the differences in the thermal behavior of the polymers within the synthesis sequence. With the exception of PEI, the polymers exhibited amorphous behavior. The PEI backbone has no side chains, allowing the main chains to be regularly packed, leading to the formation of crystallites with a melting temperature (Tₘ) at 62° C. The introduction of randomly distributed amide groups by oxidation disrupted the packing, leading to an amorphous behavior of oxPEI. Similar to PEtOx, dPEtOx also exhibited amorphous behavior, both with glass transition temperature (T_{g}) values above the T_{g} of oxPEI due to the existence of side chains. dPEtOx exhibited the highest T_{g} within the sequence due to both the irregularity of the polymer backbone due to the statistically distributed amide groups and N-acyl side chains.

From the DSC thermograms of the dPAOx polymers in FIG. 5, as well as from the relationships between the T_{g} and Tₘ values and the number of carbon atoms in the dPAOx side chain and the comparison with the T_{g} and Tₘ values of non-degradable PAOx in FIG. 6, the following information can be obtained.

Significant differences in thermal behavior were observed depending on the structure of the polymer side chain. Analogous to their PAOx counterparts, the dPAOx with short n-alkyl side chains exhibited amorphous properties up to the degradable poly-(2-n-hexyl-2-oxazoline) analog (dHexOx). The T_{g} values decreased linearly with increasing side chain length with similar slope for both series, especially for dPAOx with longer side chains. Macromolecules with only short side chains can be packed more tightly, resulting in a stronger interaction between the amide dipoles, which slows down the relaxation of the backbone, leading to higher T_{g} values. However, a gap was observed between the T_{g} of dPEtOx at 75° C. and the T_{g} of dPPropOx at 24° C. Consequently, the T_{g} values of dPMeOx and dPEtOx were higher than the T_{g} values of PMeOx and PEtOx, while all other dPAOx glass transition temperatures were at lower temperatures than their nondegradable PAOx analogs. According to their T_{g} values above room temperature, dPMeOx and dPEtOx appeared macroscopically as solids, while dPPropOx and the dPAOx with longer side chains formed highly viscous liquids caused by their glass transitions below room temperature

Semicrystalline behavior was observed for the degradable poly(2-n-heptyl-2-oxazoline) (dPHeptOx), poly(2-n-octyl-2-oxazoline) (dPOctOx) and poly(2-n-nonyl-2-oxazoline) (dPNonOx) analogs. The semicrystalline properties, which occurred only for dPAOx with side chains of at least seven carbon atoms, can be attributed to side-chain crystallization analogous to PAOx. However, PAOx exhibits semicrystallinity even with shorter alkyl substituents. The difference can be attributed to the irregularity in the dPAOx backbone due to the additional, statistically distributed glycine units.

The Tₘ values of dPHeptOx, dPOctOx, and dPNonOx were more than 100° C. lower than the Tₘ values of the corresponding PAOx of about 150° C. The melting points increased with increasing side chain length of Tₘ from 9° C. for dPHeptOx to a Tₘ of 28° C. for dPNonOx, while the Tₘ values of PAOx were independent of side chain length. Moreover, asymmetric triple melting peaks were observed for dPAOx with longer side chains, while the corresponding PAOx showed only one symmetric melting peak. The asymmetry became less pronounced with increasing side chain length. Similar asymmetric double melting peaks were previously observed for poly(2-n-butyl-2-oxazoline) as well as for other semicrystalline polymers such as poly(ethylene terephthalate), poly(ether ketone), poly(L-lactic acid) or chiral poly(2-oxazolines) and can be explained by recrystallization of the melt.

### Example C6: Characterization of the Polymers by Degradation Studies by Means of Acidic Hydrolysis

An important advantage of dPAOx compared to PAOx is their ability to be potentially degradable due to the additional backbone amide groups. To confirm this, PEtOx, PEI, oxPEI, and the water-soluble dPAOx, namely dPMeOx, dPEtOx, and dPPropOx, were treated with 6 M HCl at 90° C. for 2 days. These conditions are similar to those used for the hydrolysis of PEtOx to PEI, in which no degradation of the PEtOx or PEI polymer backbone occurs.

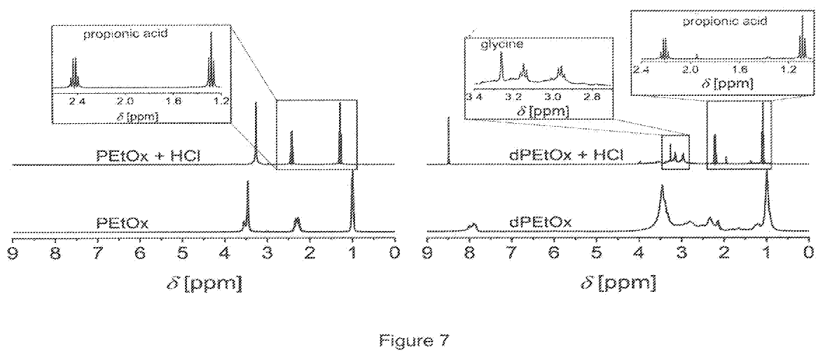

FIG. 7 shows the superposition of the ¹H NMR spectra of PEtOx (left) and of dPEtOx (right) before (lower spectrum) and after (upper spectrum) treatment with HCl (400 MHz, 297 K, D₂O, solvent signals suppressed). The individual spectra are superimposed vertically for clarity.

FIG. 7 shows the successful degradation of dPAOx polymers under these conditions. Before treatment with HCl, dPEtOx showed broad signals typical of polymers, while the signals of the degraded dPEtOx were sharp, as is commonly observed for small molecules.

The splitting of the EtOx side chain signals at 1.04 ppm and 2.16 ppm into a triplet and a quartet, respectively, indicated the cleavage of the side chain from the polymer backbone, yielding propionic acid. This did not necessarily confirm the degradation of the polymer chain itself and was also found for PEtOx upon treatment with HCl. However, while the spectra of PEtOx after treatment showed only the backbone signal of the remaining PEI, several sharp signals appeared upon chemical shifts of the former dPEtOx backbone. The singlet at 3.21 ppm can be attributed to the methylene unit of glycine formed upon degradation, while the two triplets at 3.91 ppm and 3.10 ppm can be attributed to the remaining ethyleneimine units. In addition, a sharp signal appeared at 8.45 ppm, which had already been reported for oxPEI after degradation and which could be due to additional degradation products. At the same time, the broad amide signal disappeared at about 8.0 ppm, indicating hydrolysis of the associated backbone amide groups.

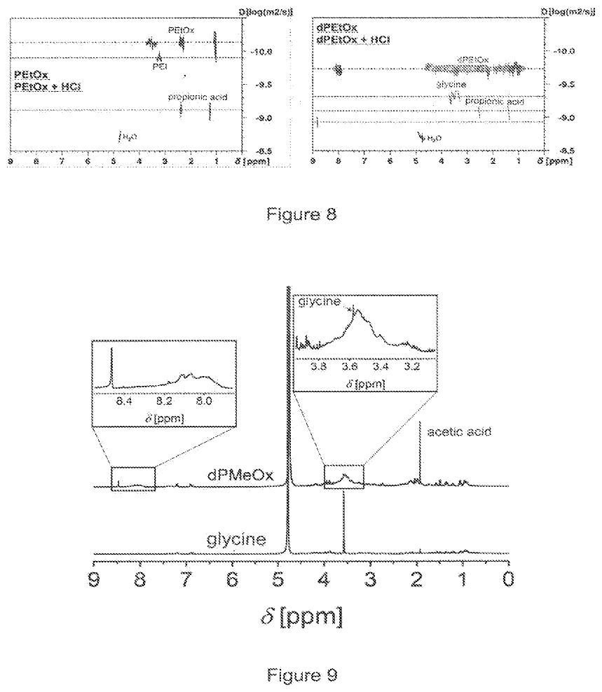

Furthermore, DOSY NMR spectroscopy was used to confirm the degradation of dPAOx. FIG. 8 shows the superposition of the DOSY NMR spectra of PEtOx (left) and dPEtOx (right) before (upper spectrum) and after (lower spectrum) treatment with HCl (400 MHz, 297 K, D₂O, solvent signals suppressed). The individual spectra are superimposed vertically for clarity. DOSY NMR spectroscopy allows fractionation of the ¹H NMR signals according to their diffusion coefficients. Before treatment with HCl, all PEtOx signals corresponded to the same diffusion coefficient and confirmed the covalent bonds between the individual groups. After hydrolysis, the cleaved propionic acid could be clearly distinguished from the undegraded PEI backbone because it had a higher diffusion coefficient due to its lower molecular mass. Before treatment with HCl, all dPEtOx signals showed the same diffusion coefficient. In contrast, the spectrum of the degraded dPEtOx showed signals with three different diffusion coefficients. The propionic acid signals formed were easy to identify because they showed the same diffusion coefficient as in the spectra of PEtOx after treatment. Therefore, the other two signals were attributed to degradation products of the former polymer backbone, for example glycine, which showed different diffusion behavior.

### Example C7: Characterization of the Polymers by Degradation Studies by Means of Enzymatic Hydrolysis

Degradation studies were carried out under enzymatic conditions to confirm the degradability of the polymers under milder and biological conditions. Therefore, dPMeOx was treated with proteinase K at 37° C. in a PBS buffer solution for 30 days.

FIG. 9 shows the superposition of the ¹H NMR spectra of dPMeOx after treatment with proteinase K in PBS buffer (upper spectrum) and of glycine with proteinase K in PBS buffer (lower spectrum) (400 MHz, 297 K, D₂O). The individual spectra are superimposed vertically for clarity.

The ¹H NMR spectrum of dPMeOx after treatment with proteinase K in FIG. 9 confirmed the partial degradation of the polymer. The sharp signal at 1.93 ppm showed the cleavage of the side chains, resulting in acetic acid in dPMeOx. The sharp signal at 8.46 ppm and the signal at 3.58 ppm were already observed for dPAOx degraded under acidic conditions, confirming the degradation of the polymer backbone. Superposition with a ¹H NMR spectrum of glycine in a proteinase K PBS buffer solution of the same concentration confirms the assignment of the latter signal to glycine.

However, the broad polymer signals of the methyl side chain, the dPMeOx backbone, and the backbone amide group can still be observed in the spectrum, indicating the slow degradation kinetics under the conditions of the experiment.

These experimental results confirm that a facile route of synthesis through polymer analog functionalizations to build a library of acidic and enzymatically degradable poly-(2-n-alkyl-2-oxazoline) analogs has been found. Copolymers were developed, which were prepared via consecutive hydrolysis of PEtOx, partial oxidation of the polymer backbone, and re-acylation of the remaining amino groups to re-introduce N-acylethylenimine units. Among the resulting dPAOx polymers, only dPMeOx and dPEtOx were water-soluble, while dPButOx and longer side-chain analogs showed hydrophobic properties.

In analogy to their non-degradable PAOx counterparts, a strong dependence of the thermal properties on the side chains was observed. dPAOx with n-alkyl side chains of up to six carbon atoms were amorphous. Similar to the shorter non-degradable PAOx, the T_{g} values of the polymers decreased with increasing number of carbon atoms in the side chain.

Higher dPAOx homologs were semicrystalline and exhibited Tₘ values that increased with the length of the n-alkyl side chains but remained below 30° C., making the novel materials attractive for a range of pharmaceutical applications, e.g., as PEG replacements.

The incorporation of glycine units facilitated the degradability of the dPAOx backbone under acidic and enzymatic conditions, highlighting their potential to be used as degradable PAOx analogues in biomedical or other applications.

1. Copolymers containing 10 to 95 mol % of structural units of the formula (I), 5 to 90 mol % of structural units of the formula (II) and 0 to 20 mol % of structural units of the formula (III)
—NR¹—CHR³—CHR⁴— (I),
—NH—CO—CHR⁷— (II),
—NH—CHR⁹—CHR¹⁰— (III),
or
copolymers containing 10 to 95 mol % of structural units of the formula (IV), 5 to 90 mol % of structural units of the formula (V) and 0 to 20 mol % of structural units of the formula (VI)
—NR¹—CHR³—CHR⁴—CHR⁵— (IV),
—NH—CO—CHR⁷—CHR⁸— (V),
—NH—CHR⁹—CHR¹⁰—CHR¹¹— (VI),
wherein
R¹ is a radical of the formula —CO—R², of the formula —CO—NH—R² or of the formula CH₂—CH(OH)—R¹²,
R³, R⁴, R⁵, R⁷, R⁸, R⁹, R¹⁰ and R¹¹ independently of one another are hydrogen, methyl, ethyl, propyl or butyl,
R² is selected from the group consisting of hydrogen, alkyl, cycloalkyl, aryl, aralkyl, —CₘH₂ₘ—X or —(CₙH₂ₙ—O)ₒ—(CₚH₂ₚ—O)_{q}—R⁶,
R⁶ is hydrogen or C₁-C₆ alkyl,
R¹² is selected from the group consisting of hydrogen, alkyl, alkenyl, cycloalkyl, aryl or aralkyl,
X is selected from the group consisting of hydroxyl, alkoxy, carboxyl, carboxylic acid ester, sulfuric acid ester, sulfonic acid ester or carbamic acid ester,
m is an integer from 1 to 18,
n and p independently of one another are integers from 2 to 4, where n is not equal to p, and
and q independently of one another are integers from 0 to 60, at least one of o or q not being equal to 0, the percentages being based on the total amount of the structural units of the formula (I), (II) and (III) or of the formula (IV), (V) and (VI).

2. Copolymers according to claim 1, wherein these contain 20 to 90 mol % of structural units of the formula (I), 10 to 80 mol % of structural units of the formula (II) and 0 to 20 mol % of structural units of the formula (III).

3. Copolymers according to claim 1, wherein R¹ is a radical of the formula —CO—R².

4. Copolymers according to claim 1, wherein R² is C₁-C₁₈-alkyl, preferably C₁-C₆-alkyl, and very preferred C₁-C₂-alkyl.

5. Copolymers according to claim 1, wherein n=2 and p=3.

6. Process for the preparation of the copolymers according to claim 1 comprising the steps of
i) reacting a polyalkyleneimine containing recurring structural units of formula (Ia) or of formula (IVa) with an oxidizing agent, thereby obtaining a copolymer containing the structural units of formula (Ia) and of formula (II) or containing the structural units of formula (IVa) and of formula (V)
—NH—CR³H—CR⁴H— (Ia),
—NH—CO—CR⁷H— (II),
—NH—CR³H—CR⁴H—CR⁵H— (IVa),
—NH—CO—CR⁷H—CR⁸H— (V),
wherein R³, R⁴, R⁵, R⁷ and R⁸ have the meaning defined in claim 1, and
ii) reacting the copolymer of step i) with an acyl derivative of the formula (VII) or with an isocyanate of the formula (VIII) or with an epoxide of the formula (IX) to give a copolymer according to claim 1
R²—CO—R¹³ (VII),
R²—NCO (VIII), 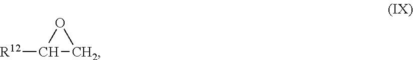
wherein R² and R¹² have the meaning defined in claim 1, and
R¹³ represents a leaving group, in particular fluorine, chlorine, bromine, iodine or an activated carboxylic acid.

7. Process for the preparation of the copolymers according to claim 1 comprising the steps of
iii) partial hydrolysis of a polyoxazoline containing recurring structural units of formula (I) or a polyoxazine containing recurring structural units of formula (IV)
—NR¹—CHR³—CHR⁴— (I),
—NR¹—CHR³—CHR⁴—CHR⁵— (IV),
to a copolymer comprising the recurring structural units of the formula (I) and the formula (III) or the formula (IV) and the formula (VI)
—NH—CHR⁹—CHR¹⁰— (III),
—NH—CHR⁹—CHR¹⁰—CHR¹¹— (VI),
wherein R¹, R³, R⁴, R⁵, R⁹, R¹⁰ and R¹¹ have the meaning defined in claim 1, and
iv) reacting the copolymer from step iii) with an oxidizing agent, thereby obtaining a copolymer containing the structural units of formula (I), of formula (II) and optionally of formula (III) or containing the structural units of formula (IV), of formula (V) and optionally of formula (VI)
—NH—CO—CHR⁷— (II),
—NH—CO—CHR⁷—CHR⁸— (V),
wherein R⁷ and R⁸ have the meaning defined in claim 1.

8. Process according to claim 6, wherein the oxidizing agent used is a peroxide, a hydroperoxide or a percarboxylic acid, preferably hydrogen peroxide.

9. Process according to claim 6, wherein the polyalkyleneimine used in step i) is obtained by acidic hydrolysis of a poly(oxazoline) or of a poly(oxazine).

10. Use of the copolymers according to claim 1 for the manufacture of formulations comprising pharmaceutical or agrochemical active ingredients.

11. Use of the copolymers according to claim 1 for applications in the field of active ingredient delivery.

12. Particles comprising copolymers according to claim 1.

13. Particles according to claim 12, wherein these are present as nanoparticles having a mean diameter D₅₀ of less than 1 μm, preferably of 20 to 500 nm.

14. Particles according to at claim 12, wherein these contain pharmaceutical or agrochemical active ingredients.
